(19) United States
(12) Patent Application Publication
(10) Pub. No.: US 2025/0272409 A1
(43) Pub. Date: Aug. 28, 2025

(54) Container Image Vulnerability Scanning Based on Vulnerability Signatures

(71) Applicant: International Business Machines Corporation, Armonk, NY (US)

(72) Inventor: Francis McNamee, Newry (GB)

(21) Appl. No.: 18/588,673

(22) Filed: Feb. 27, 2024

(51) Int. Cl. G06F 21/57

(52) U.S. Cl. CPC G06F 21/577; G06F 2221/033

(57) ABSTRACT

Mechanisms are provided for scanning container images for vulnerabilities. With these mechanisms, a container image is received for inclusion in a container image registry and each layer of the container image is scanned to generate file signatures for each file referenced in each layer. Vulnerability signature(s) are applied to each layer, based on the file signatures of the layer, to determine if criteria of the vulnerability rule(s) of the vulnerability signature(s) are satisfied by at least one layer of the container image. Registration of the container image in the container image registry is accepted or denied based on results of the application of the vulnerability signature(s). Each vulnerability signature comprises one or more vulnerability rules generated from a scanning and indexing of layers of one or more other container images.

### BACKGROUND

The present application relates generally to an improved data processing apparatus and method and more specifically to an improved computing tool and improved computing tool operations/functionality for performing container image vulnerability scanning based on vulnerability signatures.

Containers are a way to bundle and run applications by specifically placing both the application code and its dependencies into a lightweight, standalone, executable environment. Because everything that is needed for running the application is packaged together into the container, applications can run more quickly and reliability regardless of the computing environment in which they are deployed. Containers have their own filesystem and their own share of processor, memory, process space, and other resources. Because they are not coupled to the underlying infrastructure, they are portable to various execution environments. Containers are generated from container images, which may be defined by the user, or which may be reused from container image repositories. The container images include all the third-party dependencies required to run the software hosted inside the container, and may be used as blueprints for containers such that a single container image may be used to create many identical containers. Examples of container technology include the Docker® container mechanisms available from Docker, Inc. and Kubernetes® (also referred to as K8s) available from the Linux Foundation. In Kubernetes®, one or more containers are provided in a basic scheduling unit referred to as a Pod.

Containers are often used in modern cloud-based applications, which are deployed as a collection of microservices running in a plurality of containers. Microservices are loosely coupled and independently deployable small components which execute to perform a portion of an application functionality and which communicate via well-defined application programming interfaces.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for scanning container images for vulnerabilities. The method comprises receiving a first container image for inclusion in a container image registry and scanning each layer of the first container image to generate file signatures for each file referenced in each layer. The method further comprises applying one or more vulnerability signatures to each layer, based on the file signatures of the layer, to determine if criteria of one or more vulnerability rules of the one or more vulnerability signatures are satisfied by at least one layer of the first container image. In addition, the method comprises accepting or denying registration of the first container image in the container image registry based on results of the application of the one or more vulnerability signatures. Each vulnerability signature in the one or more vulnerability signatures comprises one or more vulnerability rules generated from a scanning and indexing of layers of one or more second container images.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram of the primary operational components of a vulnerability signature based vulnerability scanning tool in accordance with one illustrative embodiment;

FIG. 3 is an example diagram of a vulnerability signature for a Log 4J vulnerability in accordance with one illustrative embodiment;

FIG. 4 is an example diagram illustrating example entries in a forward index and inverted index of a vulnerability signature database in accordance with one illustrative embodiment;

FIG. 5 is an example diagram illustrating how some vulnerability rules can depend on previous rule matches in accordance with one illustrative embodiment;

FIG. 6A is an example diagram illustrating an example rule generation and vulnerability signature creation in accordance with one illustrative embodiment;

FIG. 6B is an example diagram illustrating an automatic simplification of a vulnerability signature after a fix/patch in accordance with one illustrative embodiment;

FIG. 7 is a flowchart outlining an example operation for indexing a container image in accordance with one illustrative embodiment;

FIG. 8 is a flowchart outlining an example operation for generating a vulnerability signature in accordance with one illustrative embodiment; and

FIG. 9 is a flowchart outlining an example operation for performing a vulnerability scan of a container image in accordance with one illustrative embodiment.

### DETAILED DESCRIPTION

The illustrative embodiments provide an improved computing tool and improved computing tool operations/functionality for performing container image vulnerability scanning based on vulnerability signatures. As noted above, containers are generated from container images which may be provided via container image repositories. Container images may be scanned for vulnerabilities prior to being stored in a container image repository or registry (hereafter referred to as a container image registry). In order to scan for vulnerabilities, existing technology requires that a package manager be installed to provide information to the vulnerability scanner. A package manager is a collection of software tools that automates the process of installing, upgrading, configuring and removing computer programs for a computer in a consistent manner. With container images, the package manager collects metadata associated with the container image such as the currently installed packages.

Package manager based vulnerability scans can only determine whether a vulnerable version of a package is present in a container image or not. However, package manager based vulnerability scans may not be able to detect packages that are installed manually in the container image. Package managers are usually only aware of packages they have installed themselves. Package managers track packages using an internal database or by searching for packages in known locations. Manually installed packages could be installed in unusual locations and would therefore be unknown to the package manager. A package could be manually downloaded from a source on the Internet rather than using the package manager and its pre-defined channels.

Furthermore, package managers cannot determine whether or not the vulnerability of that vulnerable version of the package has been mitigated. Software features can usually be enabled and disabled by modifying a configuration file. Often editing this file to disable a vulnerable feature will mitigate a vulnerability. Modern software often has many dependencies on existing software. It is often these dependencies that contain the vulnerabilities, updating or replacing the vulnerable dependency will mitigate the vulnerability and make the software safe. For example, the vulnerability named ‘Log 4Shell’ can be mitigated by setting an environment variable in the operating system. Thus, mitigations may be applied to the container image to resolve any known vulnerability issues and make the packages of the container image safe to use, but such mitigations are not able to be identified by package manger based vulnerability scanners as they only determine the presence or non-presence of vulnerable versions of packages.

Moreover, package managers themselves can introduce vulnerabilities which cannot be removed because existing vulnerability scanners cannot determine which packages are installed in the container image without the package manager. For example, a popular package manager used by RedHat's Enterprise Linux is called RPM, and CVE-2021-35937 (see https://access.redhat.com/security/cve/CVE-2021-35937) is an example of a vulnerability in RPM itself which enables an attacker to gain unrestricted access to the host computer. Thus, a type of “Catch-22” situation is presented in that the package manager is required to be installed for existing vulnerability scanners to scan for vulnerabilities, yet the package manager itself may introduce vulnerabilities which cannot be identified by the vulnerability scanners.

Another approach to identifying vulnerable container images involves collating results from multiple vulnerability scanners to generate an overall threat score for the container image. Such an approach for generating an overall threat score for a container image still relies on package managers for each of the vulnerability scanners. That is, because this scoring approach relies on a plurality of vulnerability scanners, each of which requires a package manager to determine if a vulnerable version of a package is present in the container image, the same issues as mentioned previously still exist.

Runtime container vulnerability scanning may also be utilized. Runtime scanning involves scanning the application layer of a container, not the container image, when the container is created from the container image. This approach to vulnerability scanning significantly reduces container start-up performance, requires the support of a container orchestration platform such as Kubernetes®, and requires a Security Information and Event Management (SIEM) system to correlate and react to security events produced by the container at runtime. It should be appreciated that only the application layer is scanned during runtime.

The illustrative embodiments, on the other hand, provide an improved computing tool and improved computing tool operations/functionality that allows for vulnerability scanning of container images, such as when container images are registered with a container image registry, without requiring the installation of a package manager. The illustrative embodiments utilize unique vulnerability signatures, comprising a set of one or more rules for identifying a corresponding specific vulnerability. A vulnerability scanner in accordance with the illustrative embodiments can scan a container image and detect whether the vulnerability signature for a vulnerability is matched by the layers in the container image without having to have a package manager to provide metadata. The mechanisms of the illustrative embodiments perform vulnerability scanning with greater accuracy than existing vulnerability scanning mechanisms, and without the need for the installation of a package manager, thereby eliminating the package manager as a potential source of vulnerability.

With the illustrative embodiments, when a container image is to be included in a container image registry, every file in every layer of the container image is indexed, unless the layer has been indexed previously. In order to perform the indexing, for each layer in the container image that has not already been indexed, a hash of each file in the layer is generated and recorded along with the metadata of the file in a database. The process of scanning each layer involves hashing every file created, removed, modified, or otherwise operated on by the layer. The metadata of the file may comprise read, write, and execute permissions for each file, environment variable settings, and/or the like. The hashes are a means of representing each file as a unique value. Hashes are only stored in the database rather than the files themselves for reasons of efficiency. Other techniques are possible too, such as compressing the file using any known lossy compression algorithm, although hashes are preferable since they represent the file uniquely using a fixed amount of memory. SHA256 and MD5 are examples of hashing algorithms that may be used to represent a file as a unique hash value.

These hashes and metadata are used to generate unique rules for each layer and file. The rules essentially specify the functionality of the corresponding layer with reference to the hash of the file, such that if the rule's conditions are satisfied, or alternatively not satisfied, then a vulnerability may be determined to exist with regard to that layer and files. The container image is processed on a layer-by-layer basis and file-by-file basis to generate the hash values for the files and store them with the metadata for the corresponding files. That is, every instruction in a container image can be roughly correlated to a layer, e.g., “RUN go mod download” is one layer, “COPY . . . ” is another layer, “ADD . . . ” is another layer, etc. When a container image is built, the builder of the container image may reuse layers from earlier builds of the container image, where the layer may be present in a build cache. If a layer has changed since a last build of the container image, then that layer and all layers that follow that layer must be rebuilt in the container image. The indexing operates on each of these layers and each file to generate hash values and associate the hash values with metadata for the files, such as permissions information, environment variable settings, or the like.

The metadata and hash values are converted into one or more vulnerability rules based on the functionality of the layer, e.g., ADD, RUN, COPY, etc. For example, if a layer of the container image adds a new file, then a rule to match the presence of the file is generated, e.g., “JndiLookup.class class file found on Java classpath”, where the file may be specified by the hash of the file. If a layer removes a file, then a rule to match the absence of the file is generated, where again the file may be specified by the hash of the file. The metadata may be used to check certain requirements of the layers with regard to the corresponding files, e.g., that certain permissions or environmental variables have/have not been set to certain settings. For example, a vulnerability rule may specify that the “LOG 4J_FORMAT MSG_NO_LOOKUPS environment variable is not set or set to false.”

In some illustrative embodiments, the rules may be represented as rows in a relational database. Each row has several columns: the file hash, file name, file location, permissions, the size of the file, and additional columns for any other relevant metadata. These types of rules can be generated automatically as each file is scanned. Every scanned file will produce one or more new unique rules, where the one or more rules may become one or more new rows in the rule database. Certain types of rules may need to be manually added to the database by a human when they are registering a new vulnerability. For example, the absence of a file may form part of a vulnerability and require its own rule which may not be able to be automatically generated. It is possible no manually created rules are needed in practice however, as the automated rules may be sufficient for most real-world vulnerabilities. An example rule would could be represented textually as follows: [ecd71870d1963316a97e3ac3408c9835ad8cf0f3c1bc703527c30265534f75ae, JndiLookup.class,/org/apache/logging/log 4j/core/lookup/, 0777, 23321]. This rule is a textual representation of a database row. The first column contains the file hash, the second column indicates the file name, the third column is the directory where the file was found, the fourth column shows the file's permissions represented as 4 bytes, such as for Linux/Unix operating systems, and the final column shows the file size in bytes.

These rules may be generated for each layer of each container image that is registered with the container image registry or which is otherwise indexed by the mechanisms of the illustrative embodiments. In this way, a database of vulnerability rules may be generated. The vulnerability rules may be combined to generate vulnerability signatures for known vulnerabilities. For example, if a container image is determined to have a vulnerability, the vulnerability rules matching the layers of the container image may be retrieved from the vulnerability rules database and used to generate a vulnerability signature for that vulnerability. Thus, the vulnerability signatures are the set of the rules which are relevant to recognizing the vulnerability. Some rules must match for the vulnerability to be detected, while other rules are not required but will increase the confidence of having detected the vulnerability. Since every file will produce one or more rules once it is scanned, and each vulnerability signature is composed of multiple rules, there will be many more rules than vulnerability signatures. Additionally, many rules will not be associated with any vulnerability at all because each rule is created whenever a file is scanned, regardless of whether the file may form part of a vulnerability or not. Since a vulnerability signature is a set of rules it may be represented textually as follows signature={([rule1 . . . ], optional=false), ([rule2 . . . ], optional=false), ([rule3 . . . ], optional=true)}. The outer brackets show the rules are enclosed within a set. Each item in the set is a rule paired with a value indicating if the rule must match or is optional. Most of the rules themselves are auto generated while scanning each file in the container image. Thus, it should be appreciated that each vulnerability may have one or more vulnerability signatures. Each vulnerability signature may have one or more vulnerability rules and each vulnerability rule may be present in multiple different vulnerability signatures.

Thus, the combination of rules for each file in the layer defines a set of vulnerability rules of the layer. The combination of rules for each layer in a container image sets forth the vulnerability signature for the corresponding known vulnerability such that if the collection of rules are matched, then the corresponding vulnerability may be detected to be present in a container image. That is, if a container image is determined to present a specific known vulnerability, e.g., the LOG 4J vulnerability, the container image may be scanned to generate the hashes and metadata for the container image layers which are then compared to the vulnerability rules in the vulnerability rules database. The matching vulnerability rules that are matched by the hashes and metadata may be retrieved and combined to generate the vulnerability signature for the vulnerability. The vulnerability signature may then be used to scan new container images that are being loaded or stored in the container image registry to make sure that they do not present vulnerabilities prior to registering them.

In some illustrative embodiments, rather than compiling the vulnerability signature from previously generated vulnerability rules, a similar process may be performed for each known vulnerability in a vulnerability database to generate the vulnerability signature from a container image known to have the known vulnerability. That is, for each known vulnerability, a corresponding container image having that vulnerability may be provided specifically for generating the vulnerability signature. That corresponding container image may be indexed on a layer and file basis as discussed above, to generate hashes of the files and corresponding metadata, and then for each layer generate one or more vulnerability rules based on the corresponding hashes and metadata and the functionality of the layer, e.g., adding, deleting, or modifying files. These vulnerability rules may then be combined to generate a vulnerability signature, i.e., a collection of vulnerability rules, for the known vulnerability. This may be done for each known vulnerability in the known vulnerability database so as to generate for each vulnerability one or more corresponding vulnerability signatures.

Thereafter, these vulnerability signatures may be checked against the layers of a new container image, such as when the new container images is being loaded or stored into a container image registry, to determine if the new container image presents any vulnerabilities, such as part of a vulnerability scan. That is, the new container image may be scanned by generating hash values for the referenced files in the layers of the container image as well as determining the metadata for these files, e.g., permissions and environment variable settings, so as to compare these hashes and metadata to the vulnerability rules to determine if there is sufficient matching to indicate a vulnerability present. The vulnerability rules are executed on the hashes and metadata to determine if the criteria of the vulnerability rules are satisfied. If so, then the container image presents a potential vulnerability. If not, then the container image is determined to be safe and may be added to the container image registry. It should be appreciated that this vulnerability scan need only evaluate the vulnerability rules for matches based on the layers of the container image itself, and does not need the installation of a package manager.

As noted previously, the illustrative embodiments provide computing tools and computing tool operations/functionality that can detect vulnerabilities and also detect whether a vulnerability has been mitigated or not. As noted above, package managers cannot recognize mitigations because they just detect vulnerabilities by looking up the installed packages in their database. Since the illustrative embodiments detect vulnerabilities based on the vulnerability's signature, mitigations can be applied that invalidate one or more of the required rules for a vulnerability, ensuring the vulnerability will no longer be matched. One example could be a vulnerable .class file being detected, but the vulnerability is then mitigated by replacing the single vulnerable class file. Since the vulnerable .class file is not detected any more, the vulnerability signature will not be matched by the vulnerability scanner. Another example may be a vulnerability being only exploitable whenever a specific software feature is enabled. Disabling this feature would mitigate the vulnerability. Configuration files are often used to enable or disable software features, so the presence or absence of a particular configuration file would indicate whether the container image is vulnerable or not, and this presence or absence of the particular configuration file may be represented in the vulnerability signature.

By indexing every file in the container image in this way, both for the vulnerability signature generation and thereafter during evaluation of new container images, not only are potential vulnerabilities identified from the files and file metadata of each layer, but this indexing also allows for detection of operating system vulnerabilities since many operating system features are exposed through the filesystem., e.g., in a Linux-based filesystem such operating system features are often exposed and may be the basis of vulnerability signature rules. Moreover, each layer of a container image need only be scanned and indexed once to generate the vulnerability rules for that layer, with other container images that reuse that layer not having to be rescanned. Thus, the vulnerability rules may be built up over time as more container images are scanned and indexed.

With the mechanisms of the illustrative embodiments, one or more new rules are generated for each file that is scanned. A rule is composed of a hash and the file metadata. The hash is a way of uniquely identifying the file without storing the file itself. Vulnerability signatures can either be generated automatically or semi-automatically, including some vulnerability signatures or parts of vulnerability signatures being manually created by a security analyst. To generate vulnerability signatures automatically the vulnerable software package is scanned and one or more rules are generated for each file in the vulnerable software. Every file will then become part of the vulnerability signature and must be matched. The illustrative embodiments can then improve the vulnerability signature whenever a fix/patched version of the vulnerable software is available by automatically scanning the fixed/patched version and comparing it to the original vulnerable version. Any files which are modified in the patched/fixed version can be deemed to cause the vulnerability, the remaining files can be deemed to not contribute to the vulnerability so their rules can become optional. They may be optional because they do not contribute to the vulnerability, but they can help to increase the scanner's confidence if it finds a vulnerability. The advantage of simplifying the vulnerability signature after a fix or patch is available is that it makes the vulnerability signature more flexible, i.e., when fewer rules need to be matched, the vulnerability is more likely to be identified.

Thus, with the mechanisms of the illustrative embodiments, every known vulnerability may be provided with a vulnerability signature generated from vulnerability rules that are automatically generated by indexing the layers of container images with regard to hashes of files correlated with file metadata in the layer. These rules may be rules that are stored in a vulnerability rules database, and which are selected, such as by matching with a container image known to have the known vulnerability, selected by a user, or the like, and combined to generate the vulnerability signature such that the vulnerability signature is the collection of rules which need to be matched for the vulnerability to be present in a container image. That is, the vulnerability signature may specify one or more previously existing vulnerability rules, e.g., rule ID, rule criteria, and an indication of whether the rule criteria should be matched (true) or not matched (false) in order to indicate a vulnerability is present, which are determined to be indicative of the vulnerability being present or not.

The number of rules in a vulnerability signature can be quite large for vulnerabilities that are complicated to exploit. Furthermore, these rules may be quite complex with regard to various dependencies of rules, e.g., if rule 1 is matched, and rule 1 is matched, but rule 4 is not matched, then if rule 5 is matched, a vulnerability is determined to exist. Moreover, for some vulnerabilities, not all rules will be required to be matched in order for a vulnerability to be detected as being present in a container image. This will depend on the nature of the vulnerability and is reflected in the vulnerability signature, as discussed hereafter. However, in some illustrative embodiments, partial matches may still be reported because sometimes it is not possible to automatically determine whether a container image is vulnerable or not and only partial matches are able to be identified. Such partial matches may be reported for further investigation by authorized users, for example.

In some illustrative embodiments, each vulnerability rule of vulnerability signature may be stored in two indices in the vulnerability signature database, i.e., a forward index and an inverted index. The forward index maps each vulnerability ID to the vulnerability's vulnerability rules in the vulnerability signature, i.e., vulnerability ID to listing of vulnerability rules. The inverted index maps the vulnerability rules to vulnerabilities based on the vulnerability signatures of the vulnerabilities, i.e., a mapping of the vulnerability rules to the vulnerability signatures that include those vulnerability rules, and thus, the corresponding vulnerabilities. A single rule may map to many vulnerabilities.

It can be appreciated that the inverted index will be much larger than the forward index because the inverted index will contain a rule for every file, even though most files will not contribute to a vulnerability. The reason for creating a rule for every file is so that when a new vulnerability is identified, existing container images will not need to be re-scanned. When a future vulnerability is identified and rules are generated for it, it is very likely those rules will already exist in the rules database because the database will store a rule for every file that has been scanned, and container images will share many common files. When a new vulnerability is identified in the future it will be associated with the relevant rules in the rules database. Since it is known which rules were generated from each container image, any time a rule belonging to a particular image has a new vulnerability associated with it, the system will know the container image is vulnerable without scanning the container image again. Storing so many rules that do not map to any vulnerabilities may seem wasteful, but it has a significant advantage in that it allows for future yet-to-be identified vulnerabilities to be identified in existing container images without rescanning and indexing those container images. Layers need only be scanned once to identify all current and future vulnerabilities.

Thus, the improved computing tool and improved computing tool operations/functionality of the illustrative embodiments assign a unique vulnerability signature to each vulnerability. This vulnerability signature can be detected automatically while scanning a container image without the need for a package manager. That is, each vulnerability is assigned a unique vulnerability signature specifying the vulnerability rules which must be true for the container image to be considered vulnerable. Each rule in a vulnerability signature can be optional and can depend on previous rule matches, enabling complex rule matching for vulnerabilities that are difficult to exploit.

These vulnerability signatures solve the problems previously discussed above with regard to vulnerability scans requiring the installation of package managers as well as the problems of existing approaches being unable to detect when a mitigation in the container image has made a vulnerability safe. Mitigations can make vulnerabilities safe because often vulnerabilities are caused by small portions of code which are only triggered in specific circumstances. When mitigating the vulnerability, one wants to disable the small portion of the code which contains the vulnerability. Typically, vulnerabilities can only be exploited in very specific circumstances, such as when a file has too many permissions. One can mitigate such a vulnerability by reducing the permissions on the file in question. The illustrative embodiments provide an improved computing tool and improved computing tool operations/functionality that permit a vulnerability scanner to detect this mitigation because the illustrative embodiments record metadata about the files that are scanned, and the metadata about each file is included in each rule, and each vulnerability's rules are combined to make up the vulnerability signature. Existing approaches cannot detect mitigations because they are only aware of the version of the package which is installed, not the permissions or content of the individual files that make up the package.

Illustrative embodiments further operate to reduce false positive detections because a vulnerability's vulnerability signature, and the vulnerability rules contained therein, will only be matched if the container image is in fact vulnerable as indicated by the criteria of the vulnerability rules. This reduction in false positives enabled by the illustrative embodiments is a significant improvement over existing approaches which merely detect the presence of a particular package as an indicator of a vulnerability. False negative are also less likely with the mechanisms of the illustrative embodiments because the mechanisms of the illustrative embodiments allow for partial vulnerability matches and reporting of such partial vulnerability matches for further investigation.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a computer implemented method, system and computer program product to perform container image vulnerability scanning based on vulnerability signatures and vulnerability rule checking. The improved computing tool implements mechanism and functionality, such as the container image vulnerability scanner, which cannot be practically performed by human beings either outside of, or with the assistance of, a technical environment, such as a mental process or the like. The improved computing tool provides a practical application of the methodology at least in that the improved computing tool is able to automatically or semi-automatically generate vulnerability rules based on the layers and files of a container image and automatically scan container images layer-by-layer to detect the presence or absence of vulnerabilities based on these generated vulnerability rules, which may be compiled into vulnerability signatures.

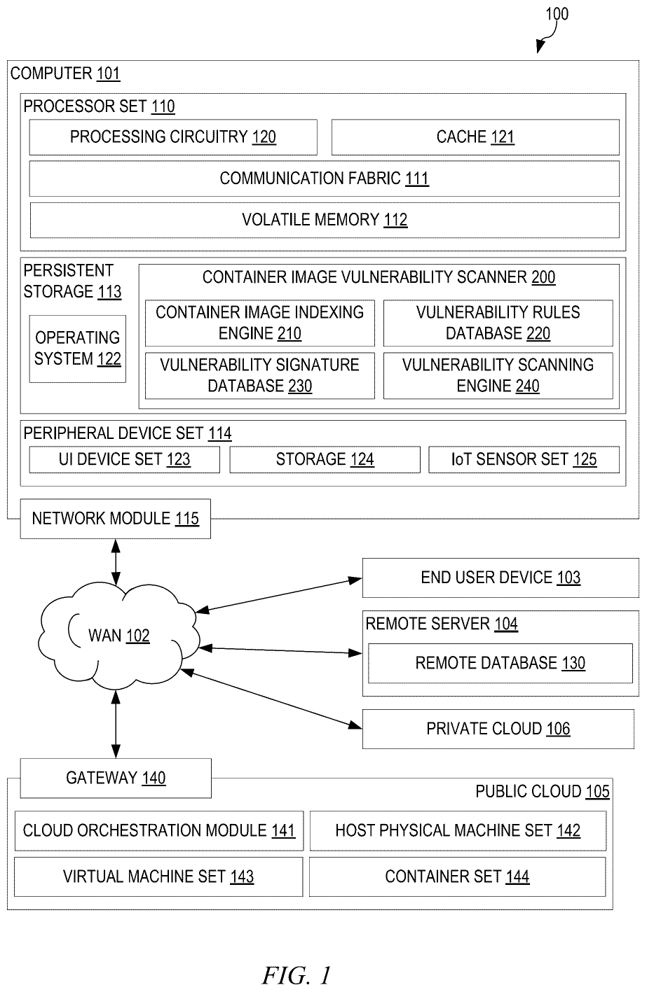

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as container image vulnerability scanner 200 comprising container image indexing engine 210, vulnerability rules database 220, vulnerability signature database 230, and vulnerability scanning engine 240. In addition to container image vulnerability scanner 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and container image vulnerability scanner 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113 and in container image vulnerability scanner 200.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in container image vulnerability scanner 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102. It should be appreciated that virtual machines use a different kind of virtualization compared to containers. Containers often run inside virtual machines or for maximum performance on ‘bare-metal’ machines which is hardware with no virtualization layer between the hardware and the operating system. Virtual machine images do not have the concept of layers like container images do, so the vulnerability scanner would need to scan every file in the virtual machine image.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a container image vulnerability scanner 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments. Container image vulnerability scanners can run locally on a developer's laptop but usually they are offered by a Cloud provider. They may be bundled as an extra feature inside a Cloud provider's Container Registry service, for example. Container registries are services for hosting container images where customers pay for storage space to host their container images.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates vulnerability scanning of container images without requiring installation of a package manager and in a manner that reduces false positives and false negatives, as well as allows for identifying situations in which vulnerabilities have been mitigated in the container image even though potentially vulnerable packages may be present.

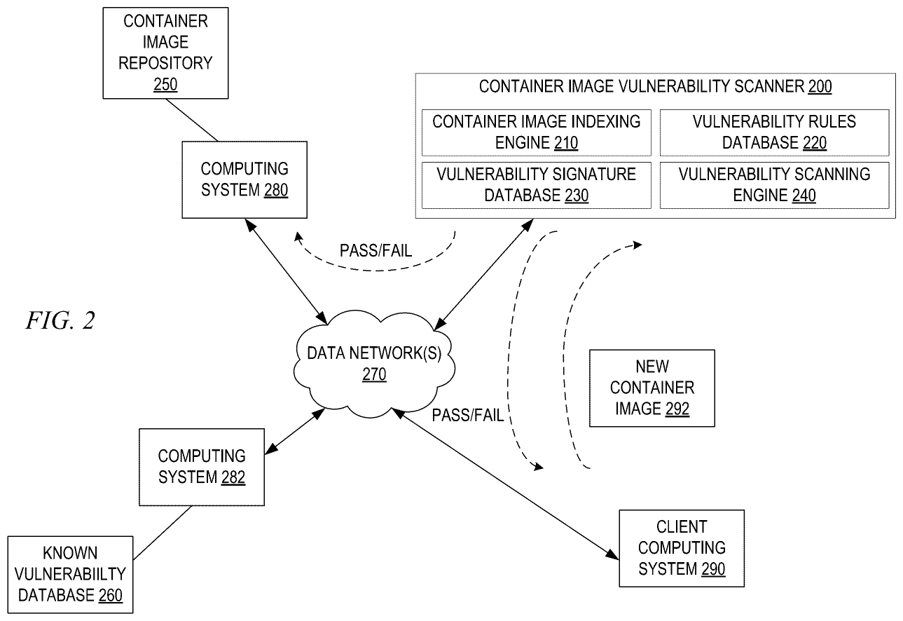

FIG. 2 is an example diagram of the primary operational components of a vulnerability signature based vulnerability scanning tool in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that vulnerability scans of container images are performed, and providing a specific solution that implements automated computer logic for generating vulnerability rules from layers of container images, generating vulnerability signatures from these vulnerability rules, and computer logic for performing automated vulnerability scanning of container images to detect such vulnerability signatures present in received container images. These operations cannot be practically performed by human beings as a mental process and are not directed to organizing any human activity. Moreover, these operations are specifically addressing the problems noted above with existing computer technology directed to vulnerability scanning of container images, such as when adding container images to container image registries for use in building applications, such as microservices based cloud computing applications or the like.

As shown in FIG. 2, the container image vulnerability scanner 200 comprises a container image indexing engine 210, vulnerability rules database 220, vulnerability signature database 230, and vulnerability scanning engine 240. The container image vulnerability scanner 200 operates in conjunction with a container image registry 250 and a known vulnerability database 260 which may be part of, or implemented by, the same computing system as the container image vulnerability scanner 200, or one or more other computing systems accessible via one or more data networks 270. For example, as shown in FIG. 2, the container image registry (or repository) 250 may be provided by a first server computing system 280 while the known vulnerability database 260 may be provided by a second server computing system 282. A client computing system 290 may provide a new container image 292 to the container image registry 250 for registration and/or the container image vulnerability scanner 200 for vulnerability scanning. If presented to the container image registry 250, the registry 250 may invoke the container image vulnerability scanner 200 to perform vulnerability scanning.

The container image registry 250 stores container images for use in deploying containers as part of an application, such as for providing a microservice or the like. Before container images are permitted to be registered in the container image registry 250, the container images are scanned for vulnerabilities to ensure that the registered container images will not introduce vulnerabilities when building applications using containers deployed from these container images. The container image registry 250 may be populated with an initial set of container images which may be submitted for scanning and indexing by the container image vulnerability scanner 200 to generate an initial set of vulnerability rules in a vulnerability rules database 220 for later use in generating vulnerability signatures for known vulnerabilities, which are then stored in the vulnerability signature database 230. These vulnerability signatures in the vulnerability signature database 230 may then be used by the vulnerability scanning engine 240 to scan new container images for matching vulnerability signatures as part of a process of determining whether to allow the new container image to be registered in the container image registry 250.

The known vulnerability database 260 may be used to identify known vulnerabilities for which vulnerability signatures should be generated by the container image vulnerability scanner and which may provide vulnerability identifiers for correlating vulnerability signatures with the known vulnerabilities. Such known vulnerabilities in the known vulnerability database 260 are described in entries of the database 260 with corresponding descriptions of the vulnerabilities. When a container image is determined to have one of the known vulnerabilities, the container image may be scanned and indexed by the container image vulnerability scanner 200 to generate and/or retrieve a set of vulnerability rules based on the layers of the container image to thereby generate a vulnerability signature for the known vulnerability and correlate the vulnerability signature, and thus its vulnerability rules, with the known vulnerability by way of the vulnerability identifier.

The container image vulnerability scanner 200 allows for vulnerability scanning of container images, such as when container images are registered with the container image registry 250, without requiring the installation of a package manager. The illustrative embodiments utilize the vulnerability signatures in the vulnerability signature database 230 generated by the container image vulnerability scanner 200, comprising a set of one or more vulnerability rules for identifying a corresponding specific known vulnerability, such as a known vulnerability in the known vulnerability database 260. The container image vulnerability scanner 200, in accordance with the illustrative embodiments can scan a container image, such as new container image 292, and detect whether a vulnerability signature in the vulnerability signature database 230 for a vulnerability is matched by the layers in the new container image 292 without having to have a package manager to provide metadata.

Prior to scanning new container images 292, the container image vulnerability scanner 200 may be executed on previously existing container images in the container image registry (or repository) 250. In so doing, the container image indexing engine 210 may execute on each of the container images in the registry 250, on a layer-by-layer basis. As described above and again hereafter, this process generates for each layer of each container image that has not already been indexed, a hash of the file(s) referenced in the layer correlated with metadata for the file to thereby generate a file signature. The file signature may then be used by the logic of the container image vulnerability scanner 200 to generate one or more vulnerability rules corresponding to the files and/or layers of the container image(s), i.e., rules data structures may be generated for each file and a combination of rules data structures for the files referenced in a layer may be combined to generate a rules data structure for the layer. These vulnerability rules are stored in the vulnerability rules database 220 and used by the container image vulnerability scanner 200 to generate vulnerability signatures for known vulnerabilities which are then stored in the vulnerability signature database 230. It should be appreciated that at the time of the creation of these vulnerability rules, it may not yet be known whether the vulnerability rule specifies a vulnerability or not, but may later be compiled into the vulnerability signature for a known vulnerability in order to specify conditions under which a container image is considered to have or potentially have the corresponding vulnerability.

Thus, container images, such as those already in the container image registry 250, or which are presented for addition to the container image registry 250, may be scanned and every file in every layer of the container image is indexed, unless the layer has been indexed previously. In order to perform the indexing, the container image indexing engine 210, for each layer in the container image that has not already been indexed, generates a hash of each file in the layer, or which is created, removed or modified by the layer, and records the hash value along with the metadata of the file in storage or database (not shown) as a file signature. The metadata of the file may comprise read, write, and execute permissions for each file, environment variable settings, and/or the like.

These file signatures, comprising the hashes and metadata, are used to generate unique vulnerability rules for each file and/or layer. The vulnerability rules essentially specify the functionality of the corresponding layer with reference to the file signatures. In some cases, such functionality in combination with the specific file signatures may be indicative of a vulnerability. In such cases, the vulnerability rule is included in a vulnerability signature for that vulnerability. Thus, as part of a vulnerability signature, if the vulnerability rule's conditions are satisfied, or alternatively not satisfied, then a vulnerability may be determined to exist with regard to that layer and files.

These rules may be generated for each file and/or layer of each container image that is registered with the container image registry 250 or which is otherwise indexed by the mechanisms of the illustrative embodiments, such as when new container images 292 are received for registration and which are determined to have layers that are not already indexed. In this way, a database 220 of vulnerability rules may be generated. The vulnerability rules may be combined to generate vulnerability signatures, i.e., combinations of vulnerability rules, for known vulnerabilities in known vulnerabilities database 260. For example, if a container image is determined to have a known vulnerability in database 260, the container image may be scanned and indexed by the container image indexing engine 210 and compared to existing vulnerability rules in the vulnerability rules database 220 to identify matching vulnerability rules for each of the layers of the container image and used to generate a vulnerability signature for that vulnerability. If a layer has not been previously scanned and indexed, a new vulnerability rule for that layer may be generated and added to the vulnerability rules database 220, as well as added to the vulnerability signature for the vulnerability. The vulnerability signature generated from combining the vulnerability rules for each of the layers of the container image may be stored in the vulnerability signature database 230 in association with an identifier of the vulnerability. This may include storing the vulnerability rules of the vulnerability signature in forward and inverse indices which correlate the vulnerability identifier with the vulnerability rules that are part of the vulnerability signature (forward index), and correlate each vulnerability rule with the vulnerability signatures that include that vulnerability rule (inverse index). It should be appreciated that each vulnerability may have one or more vulnerability signatures. Each vulnerability signature may have one or more vulnerability rules and each vulnerability rule may be present in multiple different vulnerability signatures.

Thus, the combination of vulnerability rules for each file in the layer defines a set of vulnerability rules of the layer. The combination of rules for each layer in a container image sets forth the vulnerability signature for the corresponding known vulnerability such that if the collection of rules are matched, then the corresponding vulnerability may be detected to be present in a container image. That is, if a container image is determined to present a specific known vulnerability, e.g., the LOG 4J vulnerability, the container image may be scanned to generate the hashes and metadata for the container image layers which are then compared to the vulnerability rules in the vulnerability rules database 220. The matching vulnerability rules that are matched by the hashes and metadata may be retrieved and combined to generate the vulnerability signature for the vulnerability which is then stored in the vulnerability signature database 230. The vulnerability signature may then be used by the vulnerability scanning engine 240 to scan new container images, e.g., new container image 292, that are being loaded or stored in the container image registry 250 to make sure that they do not present vulnerabilities prior to registering them in the registry 250.

In some illustrative embodiments, rather than compiling the vulnerability signature from previously generated vulnerability rules in the database 220, a similar process may be performed for each known vulnerability in a vulnerability database 260 to generate the vulnerability signature from a container image known to have the known vulnerability. That is, for each known vulnerability, a corresponding container image having that vulnerability may be provided specifically for generating the vulnerability signature. That corresponding container image may be indexed by the container image indexing engine 210 on a layer and file basis as discussed above, to generate hashes of the files and corresponding metadata, i.e., file signatures, and then for each layer generate one or more vulnerability rules based on the corresponding file signatures and the functionality of the layer, e.g., adding, deleting, or modifying files. These vulnerability rules are stored in the database 220 and may then be combined to generate a vulnerability signature, i.e., a collection of vulnerability rules, for the known vulnerability which is stored in the vulnerability signature database 230. This may be done for each known vulnerability in the known vulnerability database 260 so as to generate for each vulnerability one or more corresponding vulnerability signatures.

Thereafter, these vulnerability signatures may be checked, by the vulnerability scanning engine 240, against the layers of a new container image 292, such as when the new container image 292 is being loaded or stored into a container image registry 250, to determine if the new container image 292 presents any vulnerabilities. That is, the new container image 292 may be scanned by generating hash values for the referenced files in the layers of the container image as well as determining the metadata for these files, e.g., permissions and environment variable settings, so as to compare these hashes and metadata to the vulnerability rules of each of the vulnerability signatures in the database 230 to determine if there is sufficient matching to indicate a vulnerability present. The vulnerability rules are executed on the file signatures, e.g., the hashes and metadata, to determine if the criteria of the vulnerability rules are satisfied. If so, then the container image 292 presents a potential vulnerability. If not, then the container image 292 is determined to be safe and may be added to the container image registry. In some cases, partial matching may also be determined and if the container image 292 is determined to partially match a vulnerability signature, then an appropriate notification may be sent to an authorized user to verify whether or not a vulnerability is present and either permit or deny registry of the container image 292. It should be appreciated that this vulnerability scan need only evaluate the vulnerability rules for matches based on the layers of the container image itself, and does not need the installation of a package manager.

Thus, with the mechanisms of the illustrative embodiments, every known vulnerability may be provided with a vulnerability signature generated from vulnerability rules that are automatically generated by indexing the layers of container images with regard to hashes of files correlated with file metadata in the layer. These rules may be rules that are stored in a vulnerability rules database 220, and which are selected, such as by matching with a container image known to have the known vulnerability, selected by a user, or the like, and combined to generate the vulnerability signature, which may be stored int eh vulnerability signature database 230, such that the vulnerability signature is the collection of rules which need to be matched for the vulnerability to be present in a container image. That is, the vulnerability signature may specify one or more previously existing vulnerability rules, e.g., rule ID, rule criteria, and an indication of whether the rule criteria should be matched (true) or not matched (false) in order to indicate a vulnerability is present, which are determined to be indicative of the vulnerability being present or not.

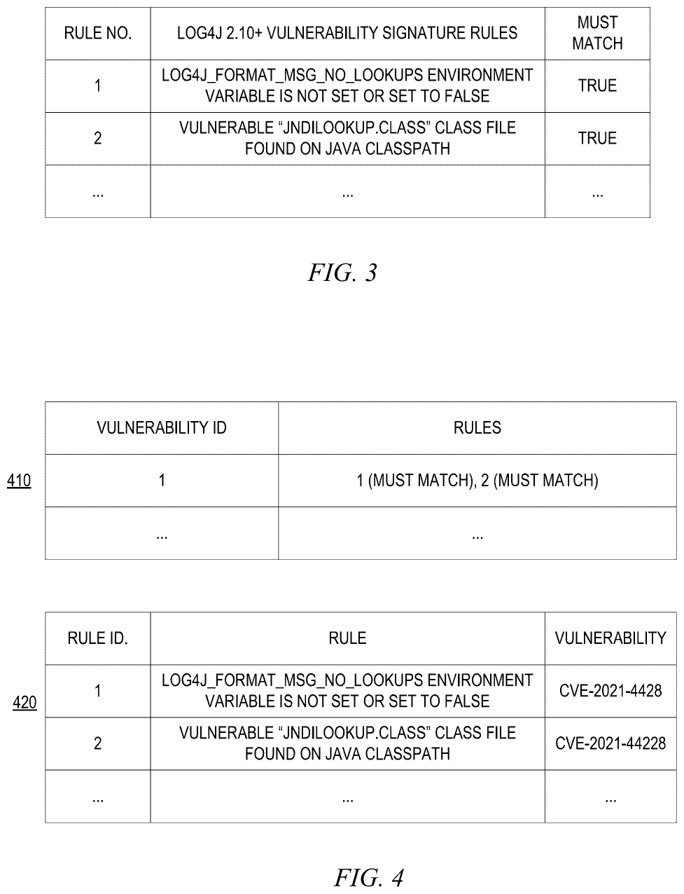

FIG. 3 is an example diagram of a vulnerability signature for a Log 4J vulnerability in accordance with one illustrative embodiment. The example shown in FIG. 3 shows two example rules which must both be matched for a container image to be considered vulnerable to the Log 4J vulnerability.

Log 4J is an open-source logging framework that is used to log messages within software and has the ability to communicate with other services on a system. It is this communication capability that causes the Log 4J vulnerability, as it provides an opening through which an attacker may inject malicious code into the logs so that it is executed on the system. That is, when Log 4J tries to log something new, the framework performs operations to attempt to make sense of the new entry and add it to the log, which may include executing the malicious code in the process. The Log 4J framework is widely used and thus, the existence of the Log 4J vulnerability is a significant concern to many applications that utilize it.

The example shown in FIG. 3 comprises the two vulnerability rules 1 and 2 which are generated by the container image vulnerability scanner 200 by scanning layers of container images. As can be seen in FIG. 3, the first rule is “LOG 4J_FORMAT_MSG_NO_LOOKUPS environment variable is not set or set to false”. On its own, this rule does not specifically state that a vulnerability is present. However, when added to a vulnerability signature and a specification of whether that rule needs to be matched or not is added, then the vulnerability rule may be considered to be indicative of a vulnerability should the match requirement be satisfied. The same is true of the second rule which states “Vulnerable JndiLookup.class class file found on Java classpath”. As indicated in the third column, the matching requirement for these rules in the vulnerability signature indicates that if the rules 1 and 2 are both found to be matched, i.e., true, then the container image is determined to have a vulnerability corresponding to the vulnerability signature, i.e., Log 4J vulnerability in this case.

As noted previously, rather than just the 2 rule example shown in FIG. 3, in other vulnerability signatures, the number of vulnerability rules may be substantially larger than the depicted example. Furthermore, these rules may be quite complex with regard to various dependencies of rules. Moreover, for some vulnerabilities, not all rules will be required to be matched in order for a vulnerability to be detected as being present in a container image, i.e., some rules may be optional and may be used as a means for providing greater or lesser confidence with regard to whether a vulnerability is present or not. In such cases if some of the vulnerability rules are evaluated and the corresponding match requirement is satisfied, but others are not, a partial match may be determined and a corresponding notification made based on a determined confidence in the matching. This will depend on the nature of the vulnerability and is reflected in the vulnerability signature.

For example, consider an example simplified vulnerability signature for the LOG 4J vulnerability which may be as follows:

| Rule ID | Hash | Filename | Location | Perm. | File Size |
|---|---|---|---|---|---|
| 1 | 3eba23a7e01a . . . | JndiLookup.class | /log4j/core/lookup/ | 0777 | 1204 |
| 2 | 0b493106b98 . . . | Core.class | log4j/core/ | 0644 | 2030 |
| 3 | 09bb5502e60 . . . | ParseException.class | log4j/core/parser/ | 0600 | 5131 |
| . . . | . . . | . . . | . . . | . . . | . . . |

This vulnerability enables an attacker to run arbitrary code against any server using the vulnerable version of the Log 4J library. This is a simplified example and it should be appreciated that the actual vulnerability signature would include all the files included in the Log 4J library. The vulnerability signature is automatically generated by scanning each file belonging to Log 4J. The example signature includes one rule which must match, i.e., rule 1, which specifies the presence of a particular vulnerable version of a file called JndiLookup.class. The remaining rules 2-3 match other files found inside Log 4J. These other files do not contribute to Log 4J's security vulnerability. However, their presence can help to identify the version of Log 4J that has been found. Multiple versions of Log 4J could include the JndiLookup.class file but the surrounding files will be different for different versions of Log 4J. If the Log 4J library is detected in a container image but cannot match every rule in the Log 4J vulnerability signature, then a partial match is obtained, however all that is needed to detect the vulnerability is to detect the presence of the JndiLookup.class, i.e., rule 1. The remaining optional rules will only match if the Log 4J vulnerability signature was generated by scanning the same version of Log 4J that was detected in the container image when the vulnerability rule was generated. The Log 4J vulnerability affects multiple versions of the library, so if there is not a vulnerability signature for every version of the vulnerability partial matches of the vulnerability signatures that have been generated may be used. In this way, partial matches may be reported for further investigation by authorized users who may determine whether a vulnerability exists and whether to allow or deny registration of the container image 292.

As mentioned previously, in some illustrative embodiments, each vulnerability rule of a vulnerability signature may be stored in two indices in the vulnerability signature database, i.e., a forward index and an inverted index. FIG. 4 is an example diagram illustrating example entries in a forward index and inverted index of a vulnerability signature database in accordance with one illustrative embodiment. As shown in FIG. 4, the forward index 410 maps each vulnerability ID to the vulnerability's vulnerability rules in the vulnerability signature, i.e., vulnerability ID to listing of vulnerability rules. The inverted index 420 maps the vulnerability rules to vulnerabilities based on the vulnerability signatures of the vulnerabilities that include that vulnerability rule, i.e., a mapping of the vulnerability rules to the vulnerability signatures that include those vulnerability rules, and thus, the corresponding vulnerabilities. A single vulnerability rule may map to many vulnerabilities. Thus, it can be appreciated that the inverted index 420 will be much larger than the forward index 410 because the inverted index 420 will contain a rule for every file, even though most files will not contribute to a vulnerability. The inverted index 420 maps rules to vulnerabilities. The inverted index 420 is useful because the rules that belong to each container image are known and the inverted index 420 allows the illustrative embodiments to find all the vulnerabilities that are associated with each rule, thereby letting enabling a look up of all the vulnerabilities belonging to any container image. If only a forward index 410 were provided, it may be necessary to scan the entire vulnerability database and check the rules associated with each vulnerability to determine if a container image is vulnerable or not. Thus, the inverted index 420 allows the lookup of the vulnerabilities associated with any container image using the container image's rules.

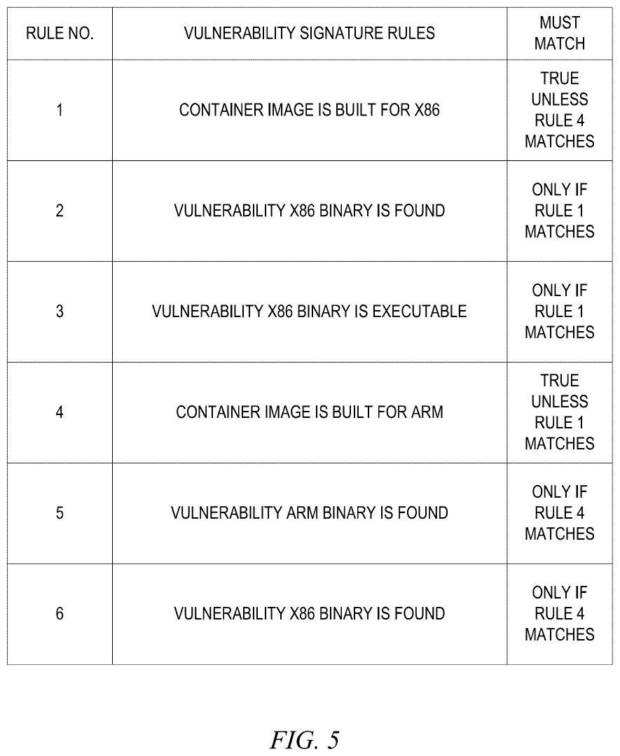

As noted above, vulnerability rules may be dependent upon each other within a vulnerability signature. Thus, the match requirement field of the vulnerability rules index may specify which vulnerability rules are dependent upon which other vulnerability rule outcomes, e.g., true/false. FIG. 5 shows how some rules can depend on previous rule matches. As shown in FIG. 5, some rules are dependent upon whether another rule is executed on the container image and results in a particular match outcome, e.g., true or false with regard to the vulnerability rule's criteria being matched. For example, Rule 1 in FIG. 5 needs to be true unless Rule 4 is matched to true. Rules 2 and 3 in FIG. 5, in order for a vulnerability to be detected as present in the container image, need to be true only if Rule 1 is matched to true. Rule 4 in FIG. 5 needs to be true only if Rule 1 is not matched to true. Rules 5 and 6 need to be matched to true only if Rule 4 is matched to true.

Thus, FIG. 5 shows rule dependencies, but also shows how a single vulnerability signature can be used to identify a vulnerable binary regardless of the underlying architecture used to compile it. That is, as shown in FIG. 5, this single vulnerability signature comprises vulnerability rules for binaries in both x86 and Advanced RISC Machine (ARM) processor architectures. The vulnerability signature shows how a vulnerable x86 binary would not necessarily cause an ARM container to be vulnerable since the binary would not be executable.

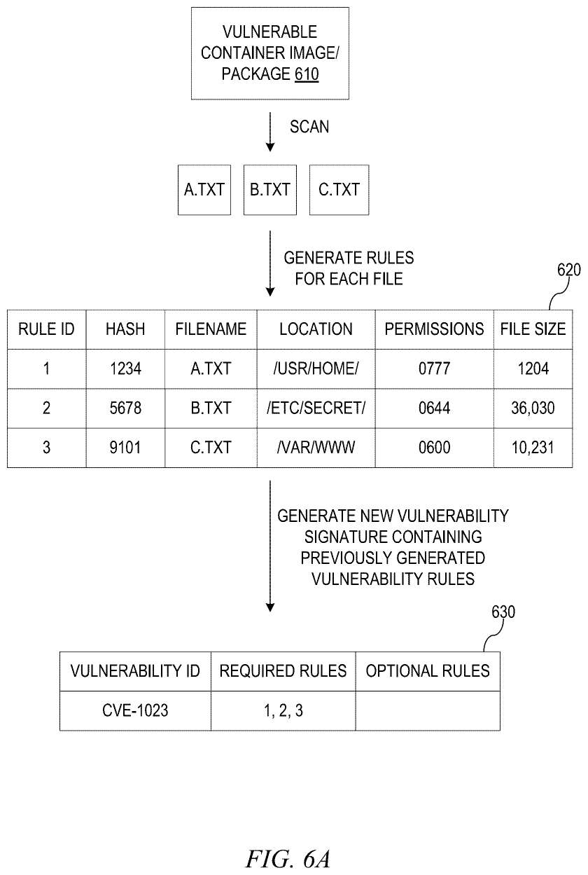

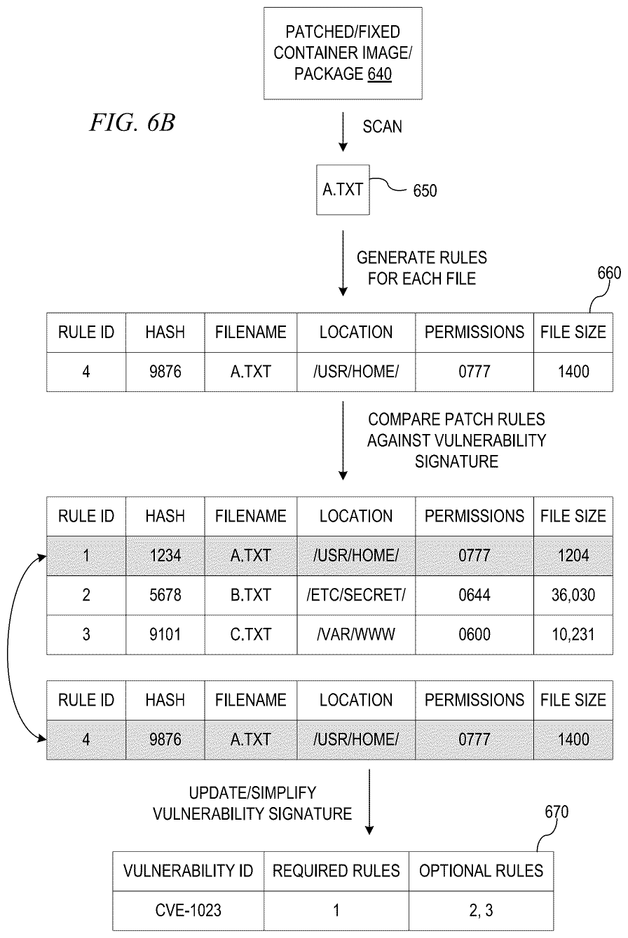

The mechanisms of the illustrative embodiments further provide functionality for updating and, in some cases, simplifying, vulnerability signatures as fixes or patches are released. FIGS. 6A and 6B show example rule and vulnerability signature generation with subsequent fix/patch based updating of vulnerability signatures in accordance with some illustrative embodiments. FIG. 6A is an example diagram illustrating an example rule generation and vulnerability signature creation in accordance with one illustrative embodiment. FIG. 6B is an example diagram illustrating an automatic simplification of a vulnerability signature after a fix/patch in accordance with one illustrative embodiment.

With reference to FIG. 6A, as described previously, each file of a container image or package 610 is scanned and vulnerability rules 620 are generated for each file of each layer of the container image/package. From these vulnerability rules 620, if it has been determined that the container image or package 610 has a vulnerability, a corresponding vulnerability signature 630 is generated for that vulnerability, e.g., the CVE-1023 vulnerability. In this case, for this vulnerability, each the vulnerability signature 630 specifies that each of rules 1-3 must be matched for the vulnerability to be detected.

As shown in FIG. 6B, at some point thereafter a patched or fixed version of the container image or package 640 is generated and is scanned. The patched or fixed version of the container image/package 640 includes a file 650 that is different from the previous version of the container image/package 610, i.e., the file a .txt in the depicted example. As such, this file will not have been previously scanned and indexed and thus, a new rule 660 is generated for this file, i.e., rule 4. The rules for the patched or fixed container image/package 640 are compared against the rules for the vulnerability in the vulnerability signature 630. In this case, rule 1 and rule 4 represent the same file, except that the file has been modified in rule 4. This is the only file that has been modified and thus, the signature of the vulnerability can be simplified automatically in that only one rule needs to be matched in the vulnerability signature. The remaining rules can become optional because they are not modified to fix the vulnerability. Thus, the simplified vulnerability signature 670 may be generated for the vulnerability and replaces the previous vulnerability signature 630.

To illustrate this simplification further, a textual version of the original, automatically generated vulnerability signature 630 may be as follows:

signature = {
([1, 1234, a.txt, /usr/home/, 0777, 1204], optional=false),
([2, 5678, b.txt, /etc/secret/, 0644, 36030], optional=false),
([3, 9101, c.txt, /var/www/, 0600, 10231], optional=false)
}

A textual version of the automatically simplified signature, after comparing the vulnerability signature 630 against the patched/fixed container image/package 640 is shown below.

signature = {
([1, 1234, a.txt, /usr/home/, 0777, 1204], optional=false),
([2, 5678, b.txt, /etc/secret/, 0644, 36030], optional=true),
([3, 9101, c.txt, /var/www/, 0600, 10231], optional=true)
}

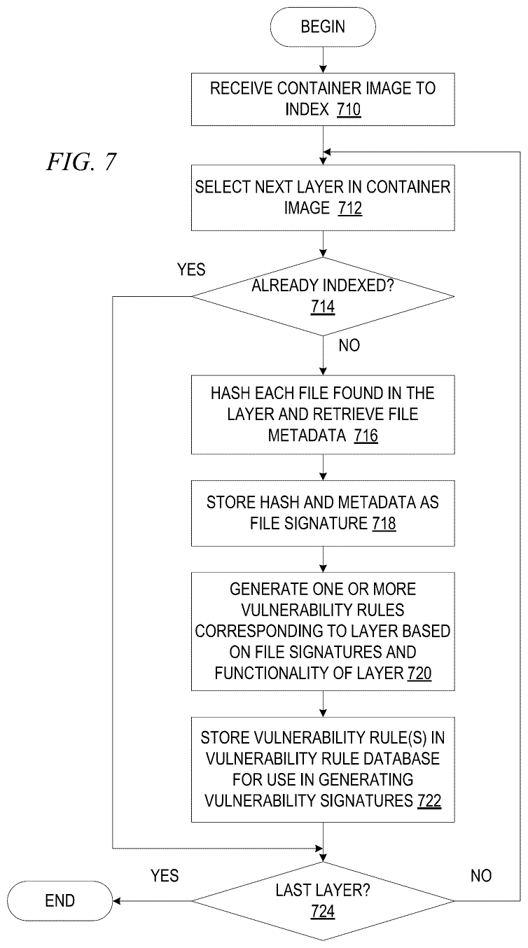

FIGS. 7-9 present flowcharts outlining example operations of elements of the present invention with regard to one or more illustrative embodiments. It should be appreciated that the operations outlined in FIGS. 7-9 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 7-9, and may, in some cases, make use of the results generated as a consequence of the operations set forth in FIGS. 7-9, the operations in FIGS. 7-9 themselves are specifically performed by the improved computing tool in an automated manner.

FIG. 7 is a flowchart outlining an example operation for indexing a container image in accordance with one illustrative embodiment. As shown in FIG. 7, the operation starts by receiving a container image to index (step 710). A next layer in the container image is selected (step 712).

A determination is made as to whether the layer has already been indexed (step 714). For example, another index may be used that maps container image layers to the rules for each layer. The container image registry already stores all the information required to map container images to the layers in the container image. Thus, if there is an entry in this additional index for the layer, then it has been indexed and does not need to be indexed again.

If the layer has already been indexed, then a determination is made as to whether this is the last layer of the container image (step 724). If not, the operation returns to step 712 and progresses to the next layer. If it is the last layer, then the operation terminates. If the layer has not already been indexed, then a hash of each file found in the layer is generated and the file metadata is retrieved (step 716). The hash and the metadata are stored as a file signature (step 718). One or more vulnerability rules are generated for the layer based on the file signatures and the functionality of the layer, e.g., if the layer adds a file, a rule is generated that checks to make sure the file is present, if the layer deletes a file, a rule is generated that checks to make sure the file is not present, etc. (step 720). These vulnerability rules are then stored in the vulnerability rule database for use in generating vulnerability signatures (step 722). The operation then checks if this was the last layer (step 724) and if not, returns to step 712; otherwise if this was the last layer the operation terminates.

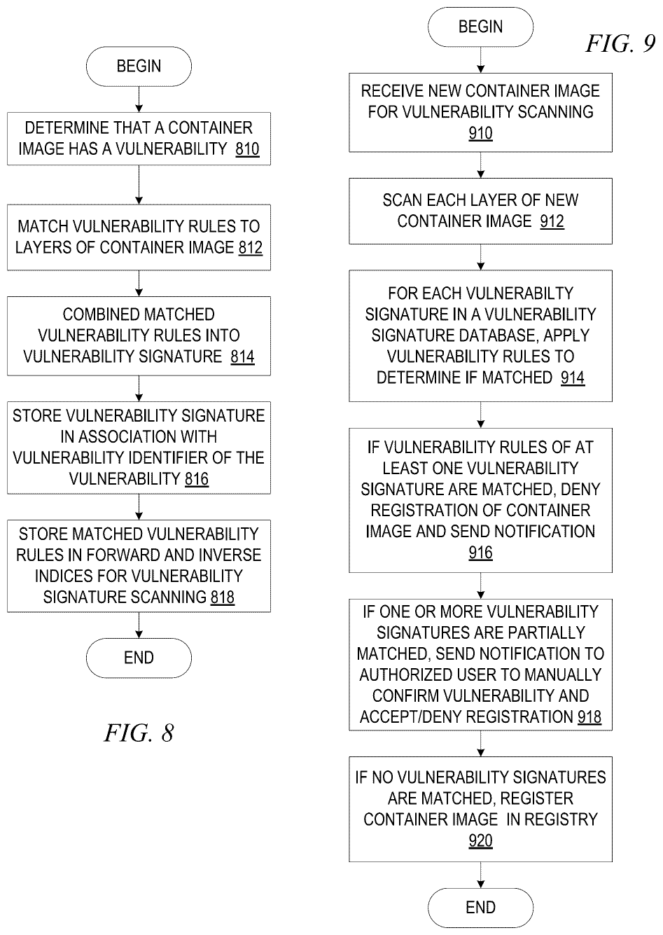

FIG. 8 is a flowchart outlining an example operation for generating a vulnerability signature in accordance with one illustrative embodiment. As shown in FIG. 8, the operation starts by determining that a container image has a vulnerability (step 810). The vulnerability rules in the vulnerability rules database are matched to the indexed layers of the container image (step 812) to identify matching vulnerability rules and layers that have not been previously indexed, which are then indexed using the mechanisms of FIG. 7 to generate one or more vulnerability rules which are added to the vulnerability rules database and to the vulnerability signature. The matched and/or newly generated vulnerability rules are then combined into a vulnerability signature for the vulnerability (step 814). The vulnerability signature is stored in association with a vulnerability identifier of the vulnerability (step 816). The vulnerability rules in the vulnerability signature are stored in forward and inverse indices for vulnerability signature scanning (step 818) and the operation terminates.

FIG. 9 is a flowchart outlining an example operation for performing a vulnerability scan of a container image in accordance with one illustrative embodiment. As shown in FIG. 9, the operation starts when a new container image is received that needs to be scanned for vulnerabilities (step 910). Each layer of the new container image is scanned and matched to an existing indexed layer or is indexed to generate the corresponding file signatures for the layer (step 912). For each vulnerability signature in the vulnerability signature database, the vulnerability rules of the vulnerability signature are applied to the file signatures of the layers of the container image to determine if the criteria of the vulnerability rules are satisfied or matched (step 914). If the vulnerability rules of at least one vulnerability signature are fully matched, the registration of the container image is denied and a corresponding notification of a vulnerability being detected is sent to the container image source and/or an authorized user associated with the container image registry for further operations (step 916). If one or more vulnerability signatures are only partially matched, then a notification is sent to the authorized user to perform a manual confirmation of the presence or absence of the vulnerability and approval or denial of the container image registration (step 918). If no vulnerability signatures are matched, then the container image may be automatically registered in the container image registry (step 920). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for scanning container images for vulnerabilities, the method comprising:
receiving a first container image for inclusion in a container image registry;
scanning each layer of the first container image to generate file signatures for each file referenced in each layer;
applying one or more vulnerability signatures to each layer, based on the file signatures of the layer, to determine if criteria of one or more vulnerability rules of the one or more vulnerability signatures are satisfied by at least one layer of the first container image; and
accepting or denying registration of the first container image in the container image registry based on results of the application of the one or more vulnerability signatures, wherein each vulnerability signature in the one or more vulnerability signatures comprises one or more vulnerability rules generated from a scanning and indexing of layers of one or more second container images.

2. The method of claim 1, further comprising, for each second container image in the one or more second container images:
scanning each layer of the second container image to generate, for each file of the layer, a file signature;
generating, for each file of each layer of the second container image, a rule data structure specifying the file signature; and
storing the rule data structures for the files of each layer of the second container image in a vulnerability rules database for use in generating the one or more vulnerability signatures.

3. The method of claim 2, wherein the file signature comprises a hash value generated by a hash function applied to the file, and further comprises metadata of the file.

4. The method of claim 3, wherein the metadata of the file comprises at least one of a filename, a location, permissions, or a file size.

5. The method of claim 2, further comprising:
determining that an identified second container image in the one or more second container images is associated with a vulnerability;
generating, for the identified second container image, a vulnerability signature comprising one or more rule data structures selected from the vulnerability rules database based on a correspondence of files in the identified second container image with the file signatures of the one or more rule data structures; and
storing the generated vulnerability signature as one of the one or more vulnerability signatures in a vulnerability signatures database.

6. The method of claim 5, wherein the one or more rule data structures selected for inclusion in the vulnerability signature comprises at least one rule data structure that is required to be satisfied for the vulnerability to be detected and at least one rule data structure that is optional and is not required to be satisfied for the vulnerability to be detected.

7. The method of claim 5, wherein determining that an identified second container image is associated with a vulnerability comprises, for each known vulnerability in a known vulnerability database, providing a second container image that is known to have that known vulnerability for scanning and generation of a vulnerability signature.

8. The method of claim 1, wherein the first container image is denied registration in the container image registry in response to application of the one or more vulnerability signatures resulting in a match of at least one layer of the first container image to at least one of the one or more vulnerability signatures, and wherein the first container image registration in the container image registry is accepted in response to application of the one or more vulnerability signatures resulting in no matches to the one or more vulnerability signatures.

9. The method of claim 2, further comprising, for each file of the first container image for which there is not an already existing rule data structure in the vulnerability rules database, generating a corresponding rule data structure based on the file signature of the file and storing the generated corresponding rule data structure in the vulnerability rules database, to thereby dynamically update the vulnerability rules database.

10. The method of claim 1, wherein the method is performed without installation of a package manager to identify vulnerable versions of packages.

11. A computer program product comprising a computer readable storage medium having a computer readable program stored therein, wherein the computer readable program, when executed on a computing device, causes the computing device to:
receive a first container image for inclusion in a container image registry;
scan each layer of the first container image to generate file signatures for each file referenced in each layer;
apply one or more vulnerability signatures to each layer, based on the file signatures of the layer, to determine if criteria of one or more vulnerability rules of the one or more vulnerability signatures are satisfied by at least one layer of the first container image; and
accept or deny registration of the first container image in the container image registry based on results of the application of the one or more vulnerability signatures, wherein each vulnerability signature in the one or more vulnerability signatures comprises one or more vulnerability rules generated from a scanning and indexing of layers of one or more second container images.

12. The computer program product of claim 11, wherein the computer readable program further causes the computing device, for each second container image in the one or more second container images, to:
scan each layer of the second container image to generate, for each file of the layer, a file signature;
generate, for each file of each layer of the second container image, a rule data structure specifying the file signature; and
store the rule data structures for the files of each layer of the second container image in a vulnerability rules database for use in generating the one or more vulnerability signatures.

13. The computer program product of claim 12, wherein the file signature comprises a hash value generated by a hash function applied to the file, and further comprises metadata of the file.

14. The computer program product of claim 13, wherein the metadata of the file comprises at least one of a filename, a location, permissions, or a file size.

15. The computer program product of claim 12, wherein the computer readable program further causes the computing device to:
determine that an identified second container image in the one or more second container images is associated with a vulnerability;
generate, for the identified second container image, a vulnerability signature comprising one or more rule data structures selected from the vulnerability rules database based on a correspondence of files in the identified second container image with the file signatures of the one or more rule data structures; and
store the generated vulnerability signature as one of the one or more vulnerability signatures in a vulnerability signatures database.

16. The computer program product of claim 15, wherein the one or more rule data structures selected for inclusion in the vulnerability signature comprises at least one rule data structure that is required to be satisfied for the vulnerability to be detected and at least one rule data structure that is optional and is not required to be satisfied for the vulnerability to be detected.

17. The computer program product of claim 15, wherein determining that an identified second container image is associated with a vulnerability comprises, for each known vulnerability in a known vulnerability database, providing a second container image that is known to have that known vulnerability for scanning and generation of a vulnerability signature.

18. The computer program product of claim 11, wherein the first container image is denied registration in the container image registry in response to application of the one or more vulnerability signatures resulting in a match of at least one layer of the first container image to at least one of the one or more vulnerability signatures, and wherein the first container image registration in the container image registry is accepted in response to application of the one or more vulnerability signatures resulting in no matches to the one or more vulnerability signatures.

19. The computer program product of claim 12, wherein the computer readable program further causes the computing device, for each file of the first container image for which there is not an already existing rule data structure in the vulnerability rules database, to generate a corresponding rule data structure based on the file signature of the file and storing the generated corresponding rule data structure in the vulnerability rules database, to thereby dynamically update the vulnerability rules database.

20. An apparatus comprising:
at least one processor; and
at least one memory coupled to the at least one processor, wherein the at least one memory comprises instructions which, when executed by the at least one processor, cause the at least one processor to:
receive a first container image for inclusion in a container image registry;
scan each layer of the first container image to generate file signatures for each file referenced in each layer;
apply one or more vulnerability signatures to each layer, based on the file signatures of the layer, to determine if criteria of one or more vulnerability rules of the one or more vulnerability signatures are satisfied by at least one layer of the first container image; and
accept or deny registration of the first container image in the container image registry based on results of the application of the one or more vulnerability signatures, wherein each vulnerability signature in the one or more vulnerability signatures comprises one or more vulnerability rules generated from a scanning and indexing of layers of one or more second container images.
